(19) United States
(12) Patent Application Publication
(10) Pub. No.: US 2026/0197692 A1
(43) Pub. Date: Jul. 9, 2026

(54) SYSTEM AND METHOD FOR GENERATING A CUSTOMER HEALTH CARD

(71) Applicant: JIO PLATFORMS LIMITED, Ahmedabad (IN)

(72) Inventors: Shyam Prabhakar MARDIKAR, Gurgaon (IN); Kausik SENGUPTA, Navi Mumbai (IN); Saurabh CHOUGHULE, Navi Mumbai (IN); Rajeev SALUJA, Gurgaon (IN); Rahul JOSHI, Jaipur (IN); Ritesh BAVISI, Mumbai (IN); Raghuram VALEGA, Mumbai (IN); Ashish GAYAL, Thane (IN); Saurabh GUPTA, Dausa (IN)

(73) Assignee: JIO PLATFORMS LIMITED, Ahmedabad (IN)

(21) Appl. No.: 19/134,534

(22) PCT Filed: Dec. 1, 2023
(86) PCT No.: PCT/IB2023/062118

§ 371 Date: May 30, 2025

(30) Foreign Application Priority Data
Dec. 1, 2022 (IN) 202221069454

(51) Int. Cl. H04W 24/10; H04W 24/08

(52) U.S. Cl. CPC H04W 24/10; H04W 24/08

(57) ABSTRACT

The present disclosure provides a system (108) and a method for generating a customer health card (CHC). The system (108) receives radio frequency (RF) trace data to determine one or more radio network everts associated with a session request. The system (108) receives one or more RF counters associated with the one or more radio network events to determine utilization of one or more radio resources during the one or more radio network events. The system (108) receives fault data associated with the one or more radio network events to determine interference in the network. The system (108) receives configuration data associated with the one or more computing devices (104) and one or more radio resources. Further, the system (108) generates the CHC based on the RF trace data, the one or more RF counters, the fault data, and the configuration data via a machine learning (ML) engine (214).

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for Long-Term Evolution (LTE)/Fourth Generation (4G)/Fifth Generation (5G) mobile networks especially addressing customer experience management, network operations, and engineering. More particularly, the present disclosure relates to a system and a method for generating a customer health card.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In most of mobile communication networks, network operations teams depend on Fault Management, Configuration Management, Accounting Management, Performance Management, and Security Management (FCAPS) functions provided by various network nodes/functions. The use of fault management and performance management functionalities enable a mobile network operator to carry out certain aspects. Certain aspects may include restoration of a fault on receiving an alarm or augmentation of capacity of a network node or signaling link when the performance counters indicate that utilization is going beyond certain pre-defined threshold.

Conventional methods of network operations aid a mobile network operator in addressing network node level issues or capacity planning related aspects. However, the existing methods of network operations are unable to identify majority of issues faced by mobile users that may include slow internet speed/throughput, poor voice quality, and frequent call drops due to a dynamic mobile coverage or a Radio Frequency (RF) environment.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method for providing a customer health card (CHC) that effectively identifies and captures issues faced by a customer.

It is an object of the present disclosure to provide a system and a method that provides the CHC to accurately map each customer's experience while providing reliable root-cause analysis, and resolution actions for the issues faced by the customer.

It is an object of the present disclosure to provide a system and a method that improves customer experience leading to a higher customer satisfaction while providing a competitive edge over other networks.

It is an object of the present disclosure to provide a system and a method that provides optimum customer experience through automated/proactive actions.

It is an object of the present disclosure to provide a system and a method that reduces customer complaints and improves efficiency of network operations through automated and accurate diagnosis of customer issues.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for generating a customer health card (CHC). The system includes a processor and a memory operatively coupled with the processor, where said memory stores instructions which, when executed by the processor, cause the processor to receive a session request from a user via one or more computing devices. The processor receives radio frequency (RF) trace data to determine one or more radio network events associated with the session request. The processor receives one or more RF counters associated with the one or more radio network events to determine utilization of one or more radio resources during the one or more radio network events. The processor receives fault data associated with the one or more radio network events to determine an interference in a network. The processor receives configuration data associated with the one or more computing devices and one or more radio resources. The processor generates, via a machine learning (ML) engine, the CHC based on the RF trace data, the one or more RF counters, the fault data, and the configuration data.

In an embodiment, the CHC may include at least one of one or more RF coverage issues, an outage impact associated with the one or more radio resources, a user experience associated with the interference, an issue with the one or more computing devices, and one or more subscriber identity module (SIM) card issues.

In an embodiment, the processor may correlate information received from the RF trace data, the one or more RF counters, the fault data, and the configuration data to generate one or more key performance indicators (KPIs) and one or more key quality indicators (KQIs) associated with the CHC.

In an embodiment, the RF trace data may include at least one of an RF signal strength associated with the one or more computing devices. The RF data may include at least one of a distance between the one or more computing devices and the one or more radio resources. The RF data may include at least one of a location of the user received associated with the one or more computing devices. The RF data may include at least one of information associated with one or more new RF connections established by the one or more computing devices. The RF data may include at least one of information associated with the one or more radio resources. The RF data may include at least one of an amount of data exchanged between the one or more computing devices and the one or more radio resources.

In an embodiment, the one or more RF counters may include at least one of a resource utilization report indicating the utilization of the one or more radio resources during the one or more radio network events. The one or more RF counters may include at least one of a service usage report indicating an amount of data exchanged between the one or more computing devices and the one or more radio resources.

In an embodiment, the configuration data may include at least one of a latitude, a longitude, an azimuth, a height, a tilt, and a Multiple-input Multiple-output (MIMO) configuration associated with a base station for communication with the one or more computing devices. The configuration data may include at least one of a configuration associated with the one or more computing devices. The configuration data may include at least one of a configuration associated with a SIM card incorporated with the one or more computing devices.

In an embodiment, the fault data may include at least one of an outage alarm indicating outage information associated with the one or more radio resources. The fault data may include at least one of an interference alarm indicating the interference in the network.

In an aspect, the present disclosure relates to a method for generating a CHC. The method includes receiving, by a processor associated with a system, a session request from a user via one or more computing devices. The method includes receiving, by the processor, RF trace data to determine one or more radio network events associated with the session request. The method includes receiving, by the processor, one or more RF counters associated with the one or more radio network events to determine utilization of one or more radio resources during the one or more radio network events. The method includes receiving, by the processor, fault data associated with the one or more radio network events to determine an interference in the network. The method includes receiving, by the processor, configuration data associated with the one or more computing devices and one or more radio resources. The method includes generating, by the processor, via an ML engine, the CHC based on the RF trace data, the one or more RF counters, the fault data, and the configuration data.

In an embodiment, the CHC may include at least one of one or more RF coverage issues, an outage impact associated with the one or more radio resources, a user experience associated with the interference, an issue with the one or more computing devices, and one or more SIM card issues.

In an embodiment, the method may include correlating, by the processor, information received from the RF trace data, the one or more RF counters, the fault data, and the configuration data to generate one or more KPIs and one or more KQIs associated with the CHC.

In an embodiment, the RF trace data may include at least one of an RF signal strength associated with the one or more computing devices. The RF trace data may include at least one of a distance between the one or more computing devices and the one or more radio resources. The RF trace data may include at least one of a location of the user associated the one or more computing devices. The RF trace data may include information associated with one or more new RF connections established by the one or more computing devices. The RF trace data may include at least one of information associated with the one or more radio resources. The RF trace data may include at least one of an amount of data exchanged between the one or more computing devices and the one or more radio resources.

In an embodiment, the one or more RF counters may include at least one of a resource utilization report indicating the utilization of the one or more radio resources during the one or more radio network events. The one or more RF counters may include at least one of a service usage report indicating an amount of data exchanged between the one or more computing devices and the one or more radio resources.

In an embodiment, the configuration data may include a latitude, a longitude, an azimuth, a height, a tilt, and a MIMO configuration associated with a base station for communication with the one or more computing devices. The configuration data may include at least one of a configuration associated with the one or more computing devices. The configuration data may include at least one of a configuration associated with a SIM card incorporated with the one or more computing devices.

In an embodiment, the fault data may include at least one of an outage alarm indicating outage information associated with the one or more radio resources. The fault data may include at least one of an interference alarm indicating the interference in the network.

In an aspect, a user equipment for sending requests may include one or more processors communicatively coupled to a processor associated with a system. The one or more processors are coupled with a memory and where said memory stores instructions which, when executed by the one or more processors, cause the one or more processors to transmit a session request to the processor. The processor is configured to receive the session request from the UE. The processor is configured to receive RF trace data to determine one or more radio network events associated with the session request. The processor is configured to receive one or more RF counters associated with the one or more radio network events to determine utilization of one or more radio resources during the one or more radio network events. The processor is configured to receive fault data associated with the one or more radio network events to determine an interference in a network. The processor is configured to receive configuration data associated with the user equipment and one or more radio resources. The processor is configured to generate, via an ML engine, the CHC based on the RF trace data, the one or more RF counters, the fault data, and the configuration data.

In an aspect, a non-transitory computer readable medium includes a processor with executable instructions that cause the processor to receive a session request from a user via one or more computing devices. The processor receives RF trace data to determine one or more radio network events associated with the session request. The processor receives one or more RF counters associated with the one or more radio network events to determine utilization of one or more radio resources during the one or more radio network events. The processor receives fault data associated with the one or more radio network events to determine an interference in a network. The processor receives configuration data associated with the one or more computing devices and the one or more radio resources. The processor generates, via an ML engine, the CHC based on the RF trace data, the one or more RF counters, the fault data, and the configuration data.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (108), in accordance with an embodiment of the present disclosure.

FIG. 2 illustrates an example block diagram (200) of a proposed system (108), in accordance with an embodiment of the present disclosure.

FIG. 3 illustrates an example block diagram (300) depicting a process for generating a customer health card, in accordance with an embodiment of the present disclosure.

FIG. 4 illustrates an example diagram (400) depicting an alarm correlation for outage and interference in the proposed system (108), in accordance with an embodiment of the present disclosure.

FIG. 5 illustrates an example architecture and a process flow (500) for implementing a method for generating a customer health card, in accordance with an embodiment of the present disclosure.

FIG. 6 illustrates an example computer system (600) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In an embodiment, the present disclosure provides a customer health card (CHC) that captures a customer service experience related to High Speed Internet (HSI) service and voice services. Further, the CHC determines specific network events including an (radio head) outage or a high radio coverage interference that causes degradation in the customer's service experience. The CHC provides information related to a mobile device and a subscriber identity module (SIM) card being used by the customer. The CHC also captures the customer's service experience in different radio frequency (RF) environments such as an indoor environment, an outdoor-stationary, or mobile environments. Hence, the CHC card helps in automating an end-to-end process for proactive problem detection and resolution associated with various problems. The CHC may represent customer perceived service experience accurately and generate a scorecard, for each customer, representing customer satisfaction/dissatisfaction as accurately as possible.

In an embodiment, the CHC may be a scorecard that reflects true service experience perceived by each customer in a mobile network. The scorecard may capture important service Key Performance Indicators (KPIs) and Key Quality Indicators (KQIs) along with voice of the customer and other allied information that may include the mobile device and SIM models used by the customer. The KPIs/KQIs and all the information captured in the CHC may help in identifying customer's satisfaction or dissatisfaction, accurately.

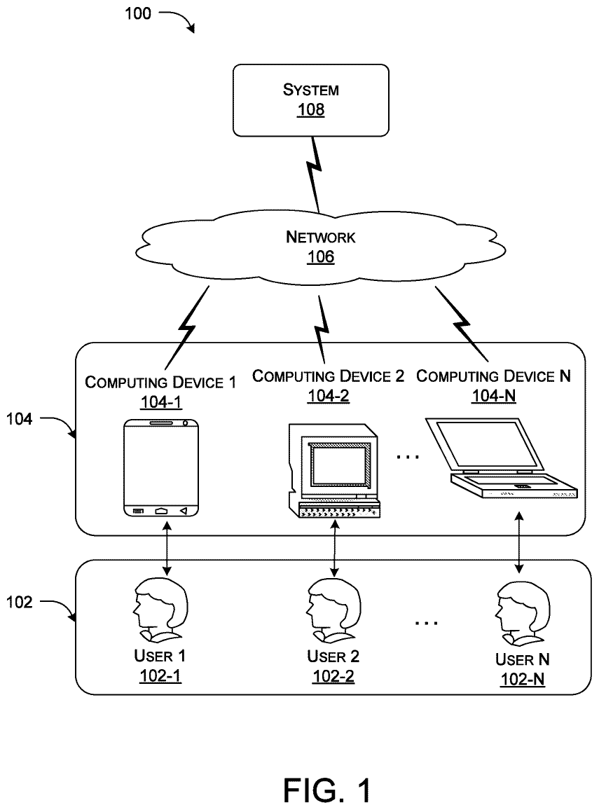

Various embodiments of the present disclosure will be explained in detail with reference to FIGS. 1-6.

FIG. 1 illustrates an example network architecture (100) for implementing a proposed system (108), in accordance with an embodiment of the present disclosure.

As illustrated in FIG. 1, the network architecture (100) may include a system (108). The system (108) may be connected to one or more users (102-1, 102-2 . . . 102-N) via a network (106). It may be appreciated that the one or more users (102-1, 102-2 . . . 102-N) may be individually referred as a user (102) and collectively referred as users (102).

In an embodiment, the exemplary network architecture (100) may include a plurality of computing devices (104-1, 104-2 . . . 104-N), which may be individually referred as the computing device (104) and collectively referred as the computing devices (104). The computing device (104) may be interchangeably referred as a user equipment (UE) (104). The plurality of computing devices (104) may include, but not be limited to, scanners such as cameras, webcams, scanning units, and the like.

In an embodiment, the computing device (104) may include smart devices operating in a smart environment, for example, an Internet of Things (IoT) system. In such an embodiment, the computing device (104) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users and/or entities, or any combination thereof.

A person of ordinary skill in the art will appreciate that the computing device or the user equipment (104) may include, but is not limited to, intelligent, multi-sensing, network-connected devices, that may integrate seamlessly with each other and/or with a central server or a cloud-computing system or any other device that is network-connected.

In an embodiment, the computing device (104) may include, but is not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the computing device (104) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the computing device (104) may include one or more in-built or externally coupled accessories including, but not limited to, a visual aid device such as a camera, an audio aid, a microphone, a keyboard, and input devices for receiving input from the user or the entity such as touch pad, touch enabled screen, electronic pen, and the like. A person of ordinary skill in the art may appreciate that the computing device (104) may not be restricted to the mentioned devices and various other devices may be used.

In an exemplary embodiment, the computing device/user equipment (104) may communicate with the system (108) through the network (106).

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive a session request from a user (102) via one or more computing devices (104). The system (108) may receive RF trace data to determine one or more radio network events associated with the session request. The RF data received by the system (108) may include an RF signal strength associated with the one or more computing devices (104). The RF data received by the system (108) may include a distance between the one or more computing devices (104) and the one or more radio resources. The RF data received by the system (108) may include a location of the user (102) associated with the one or more computing devices (104). The RF trace data received by the system (108) may include information associated with one or more new RF connections established by the one or more computing devices (104). The RF trace data received by the system (108) may include information associated with the one or more radio resources. The RF trace data received by the system (108) may include an amount of data exchanged between the one or more computing devices (104) and the one or more radio resources.

In an embodiment, the system (108) may receive one or more RF counters associated with the one or more radio network events to determine a utilization of the one or more radio resources during the one or more radio network events. The one or more RF counters received by the system (108) may include a resource utilization report based on the utilization of the one or more radio resources during the one or more radio network events. The one or more RF counters received by the system (108) may include a service usage report indicating the amount of data exchanged between the one or more computing devices (104) and the one or more radio resources.

In an embodiment, the system (108) may receive a fault data associated with the one or more radio network events to determine an interference in the network (106). The fault data received by the system (108) may include an outage alarm indicating outage information associated with the one or more radio resources. The fault data received by the system (108) may include an interference alarm indicating the interference in the network (106).

In an embodiment, the system (108) may receive configuration data associated with the one or more computing devices (104) and the one or more radio resources. The configuration data received by the system (108) may include a latitude, a longitude, an azimuth, a height, a tilt, and a Multiple-input Multiple-output (MIMO) configuration associated with a base station for communication with the one or more computing devices (104). The configuration data received by the system (108) may include a configuration associated with the one or more computing devices (104). The configuration data received by the system (108) may include a configuration associated with a SIM card incorporated with the one or more computing devices (104).

In an embodiment, the system (108) may generate, via a machine learning (ML) engine, the CHC based on the RF trace data, the one or more RF counters, the fault data, and the configuration data. Further, the CHC generated by the system (108) may include one or more RF coverage issues, an outage impact associated with the one or more radio resources, a user experience associated with the interference, an issue with the one or more computing devices (104), and one or more SIM card issues.

In an embodiment, the system (108) may correlate information received from the RF trace data, the one or more RF counters, the fault data, and the configuration data to generate one or more KPIs and one or more KQIs associated with the CHC.

In an embodiment, the system (108) may determine the user's (102) average (for each day) RF coverage experience in terms of a site, a sector, a cell, and a frequency band to which the user (102) was latched-on for majority of duration of the day.

In an embodiment, the system (108) may determine the user's (102) service experience in terms of a percentage of total RF connections that had poor RF coverage, a percentage of voice calls that had poor RF coverage, and a percentage of packet data sessions that had poor RF coverage.

In an embodiment, the system (108) may determine a voice of the user (102) in terms of one or more RF coverage related complaints, one or more voice call related complaints, one or more packet data service-related complaints. Further, the system (108) may determine if the user/customer (102) may have requested for porting-out his/her mobile number.

In an embodiment, the system (108) may determine a daily consumption of services by the user (102) in terms of a total data volume consumed, a number of mobile originating (MO) calls made, a total call duration of MO calls, a number of mobile terminating (MT) calls received, and a total call duration of MT calls.

In an embodiment, the system (108) may determine the computing devices (102) used by the user (102), a make and model of the computing devices (102), and an indication of whether the computing device (102) supports lower frequency band (850 Megahertz (MHz)) for better indoor coverage. Further, the system (108) may include an indication of whether the computing device (102) supports carrier aggregation to support higher throughput. The system (108) may include an indication of whether the computing device (104) is an “end-of-life” device.

In an embodiment, the system (108) may include an indication of whether the user (102) faces service degradation or complete service outage due to a site or cell (RF Head) outage. Further, the system (108) may include an indication of whether the given user (102) faces service degradation or the complete service outage due to powerful interferences in one or more radio channels. Further, the system (108) may include the SIM card details and a packet data throughput experienced by the users (102).

In an embodiment, the CHC may be part of a customer close looping (CCL) system. The CHC may capture the overall health of customer's experience. The CHC may include a proactive/system generated customer experience score card based on various network events and custom events defined in CHC and/or KPIs and KQIs. The CHC may include customer's own voice (customer complaints data and any mobile number portability requests generated by the customer) and other allied information that may include, but not limited to, the computing device (104) (make/model) being used by the customer/user (102) and a version of the SIM card being used.

In an embodiment, the CHC may be built on top of a Big Data Lake (BDL) platform. Data from various data sources may be ingested in the BDL. The CHC may include RF transactions data/traces including measurement reports received from individual users (102) and their computing devices (104). The CHC may include performance counters of all the cells (radio head) in the network (106). The CHC may include the configuration data and various alarms (e.g., cell or site outage alarms, interference alarms, infra-alarms, etc.).

In an embodiment, the system (108) may use outage alarms whenever a cell site (radio head) experiences an outage (e.g., due to infrastructure failure such as power outage, a poor battery, or a diesel generator (DG) set failure or due to a connectivity loss resulting from a fiber cut). All the users (102) being served by the cell site may lose their radio connection. Some of the users (102) may get latched on to neighbouring cell sites (radio heads) that may have overlapping radio coverage with the cell site that has failed. However, some of the users (102) may not be able to latch on to any other cell site due to a coverage hole created during the outage of the cell site to which the users (102) latch on. This may include neighbouring cells that had an overlapping coverage and already in an overloaded condition. Hence, such cells may not accommodate additional users (102).

In another case, some of the users (102) may get latched on to the neighbouring cells, but due to temporary overload conditions prevailing in those cells, some of the users (102) may face poor service quality (though, not complete service outage). All such experiences and their impacts due to the cell site outage may be indicated in the CHC. Such data may be available on a daily basis for several days and help in identifying cells that may be frequently affected and an impact associated with their outage may be easily gauged through CHC data and corrective actions may be prioritized.

In an embodiment, the system (108) may use interference alarms whenever the cell site (radio head) experiences a heavy interference in the radio frequency band. Whenever the signal strength of the interfering signal goes below a predefined threshold, the interference alarm may be closed. During the time period between these two events, the onset of the interference alarm and an abatement, all the users (102) being served by the given cell site may be affected. Further, information between the computing devices (104) of the cell site may also be affected. In such conditions, the computing devices (104) served by a different frequency band but served by same site may not have any interference issues. The neighbouring cells having an overlapping coverage with different frequency bands may also be unaffected. However, some of the users (102) may not receive any service due to an inability of their computing devices (104) to latch onto another frequency band or may get degraded service due to latching onto overloaded cells. All such experience impacts due to interference may be indicated in the CHC. Such data may be available on daily basis for several days and help in identifying the cells that may be frequently affected. Further, impact of interference issues may be easily gauged through the CHC data and corrective actions may be prioritized.

In an embodiment, the system (108) may include details from the computing devices (104). SIM card details (SIM version), and usage data from the users (102). Some existing modules use these data sources and some modules may be planned for integration in CCL based on the CHC data. Further, the CHC may include information causing poor users (102) experiences.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

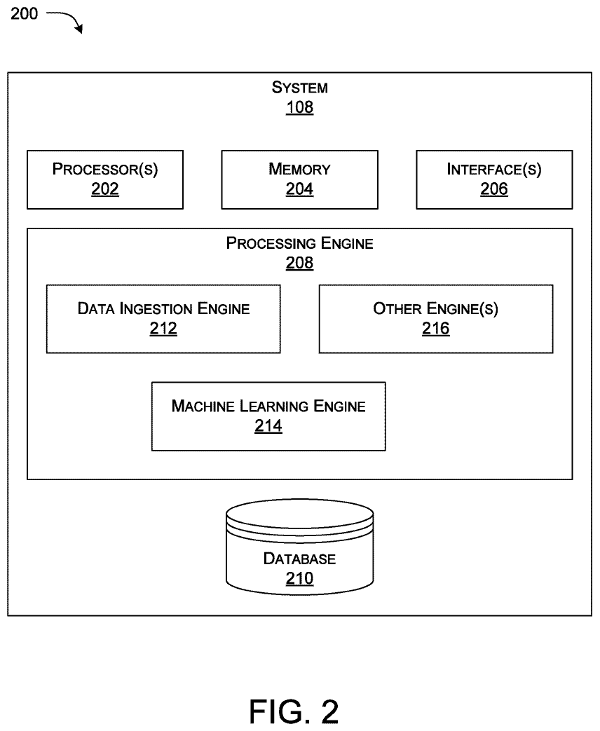

FIG. 2 illustrates an example block diagram (200) of a proposed system (108), in accordance with an embodiment of the present disclosure.

Referring to FIG. 2, the system (108) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (108). Examples of such components include, but are not limited to, processing engine(s) (208) and a database (210), where the processing engine(s) (208) may include, but not be limited to, a data ingestion engine (212), the ML engine (214), and other engine(s) (216). In an embodiment, the other engine(s) (216) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the processor (202) may receive a session request via the data ingestion engine (212). The processor (202) may store the session request in the database (210). The processor (202) may receive RF trace data to determine one or more radio network events associated with the session request. The RF trace data received by the processor (202) may include an RF signal strength associated with the one or more computing devices (104). The RF trace data received by the processor (202) may include a distance between the one or more computing devices (104) and the one or more radio resources. The RF trace data received by the processor (202) may include a location of the user (102) associated with the one or more computing devices (104). The RF trace data received by the processor (202) may include information associated with one or more new RF connections established by the one or more computing devices (104). The RF trace data received by the processor (202) may include information associated with the one or more radio resources. The RF trace data received by processor (202) may include an amount of data exchanged between the one or more computing devices (104) and the one or more radio resources.

In an embodiment, the processor (202) may receive one or more RF counters associated with the one or more radio network events to determine utilization of one or more radio resources during the one or more radio network events. The one or more RF counters received by processor (202) may include a resource utilization report based on the utilization of the one or more radio resources during the one or more radio network events. The one or more RF counters received by the processor (202) may include a service usage report indicating the amount of data exchanged between the one or more computing devices (104) and the one or more radio resources.

In an embodiment, the processor (202) may receive fault data associated with the one or more radio network events to determine an interference in the network (106). The fault data received by the processor (202) may include an outage alarm indicating outage information associated with the one or more radio resources. The fault data received by the processor (202) may include an interference alarm indicating the interference in the network (106).

In an embodiment, the processor (202) may receive configuration data associated with the one or more computing devices (104) and one or more radio resources. The configuration data received by the processor (202) may include a latitude, a longitude, an azimuth, a height, a tilt, and a MIMO configuration associated with a base station for communication with the one or more computing devices (104). The configuration data received by the processor (202) may include a configuration associated with the one or more computing devices (104). The configuration data received by the processor (202) may include a configuration associated with a SIM card incorporated with the one or more computing devices (104).

In an embodiment, the processor (202) may generate, via a machine learning (ML) engine (214), the CHC based on the RF trace data, the one or more RF counters, the fault data, and the configuration data. Further, the CHC generated by the processor (202) may include one or more RF coverage issues, an outage impact associated with the one or more radio resources, a user experience associated with the interference, an issue with the one or more computing devices (104), and one or more SIM card issues.

In an embodiment, the processor (202) may correlate information included in the RF trace data, the one or more RF counters, the fault data, and the configuration data to generate one or more KPIs and one or more KQIs associated with the CHC.

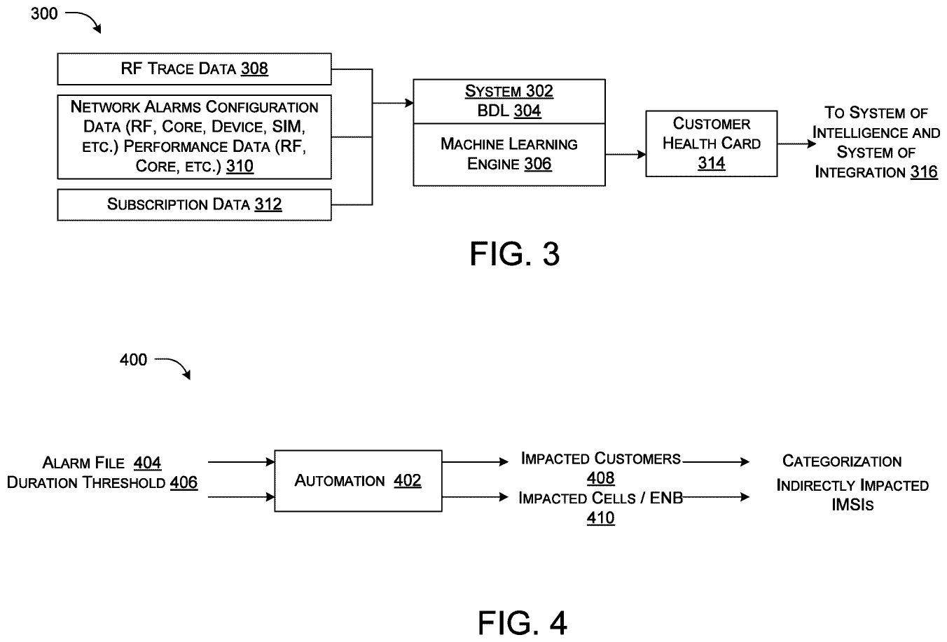

FIG. 3 illustrates an example block diagram (300) depicting a process for generating a customer health card, in accordance with an embodiment of the present disclosure.

As illustrated in FIG. 3, in an embodiment, the system (302) (system (108) of FIG. 1) may include the BDL (304) and an ML engine (306). The ML engine (306) may include a correlation engine and an analytical engine. The system (302) may receive RF trace data (308), one or more network alarms/configuration data/performance data (310), and subscription data (312). The system (302) may generate the CHC card (314) based on the various inputs and integrate the CHC card (314) with a system of intelligence and a system of integration (316).

In an embodiment, the RF trace data (308) may include RF signaling traces and measurement reports generated by the computing devices (104) captured by each cell/site (RF head). The RF trace data (308) may capture all of the radio network events with key parameters that may include, but not limited to, a RF signal strength reported by the computing device (104), a distance of the user/customer (102) from the cell (RF head), a location of customer, a reason for a new RF connection (handover, fresh attach, redirection, etc.), and a reason for release of a RF connection. Further, the RF trace data (308) may include the RF environment (e.g., inter-site-distance, signal strengths of neighbouring cells as ported by customer's computing device (104)) of the cell to which the customer is latched-on and a volume of the data exchanged (downloaded and uploaded) for each service (voice and packet data service).

In an embodiment, the RF trace data (308) may include various RF performance counters with resource utilization reports and the service usage reports. The resource utilization reports may indicate the utilization of various resources of each cell (RF Heads). If the radio resources are overloaded, then customer experience may be degraded. The service usage reports may indicate the data volume exchanged in each direction (from the computing device (104) to the cell and vice versa).

In an embodiment, the RF trace data (308) may include fault or alarms data indicating an onset or abatement of certain events such as, outage or interference in the network (106).

In an embodiment, the configuration data (310) may include various types of configuration data ingested in the BDL (304). Further, the configuration data (310) may include configuration data of all the cells (including latitude/longitude, azimuth, height, tilt, MIMO configuration, propagation model, etc.), configuration data of all the computing devices (104) (mapping of the computing device (104) identification (ID) with make, model, features supported, end-of-life status), and the configuration data of all SIM cards.

In an embodiment, the ML engine (306) may include custom logic and algorithms used to process data available in the BDL (304) and correlate data from various sources to generate accurate KPIs. Automated logics and algorithms may be used to indicate a customer experience impact within the CHC card (314). This may include RF coverage issues, cell/site outage impact in customer experiences, an impact on the customer experience due to high interferences in the cell/site, issues with the computing device (104), and issues with the SIM card.

FIG. 4 illustrates an example diagram (400) depicting an alarm correlation for outage and interference in the proposed system (108), in accordance with an embodiment of the present disclosure.

As illustrated in FIG. 4, in an embodiment, an automation module (402) included in the system (108) may receive an alarm file (404) and a duration threshold (406). The automation module (402) may categorize impacted customers (408) and impacted cells/eNB (410). The impacted cells/eNB (410) may include indirectly impacted international mobile subscriber identities (IMSIs).

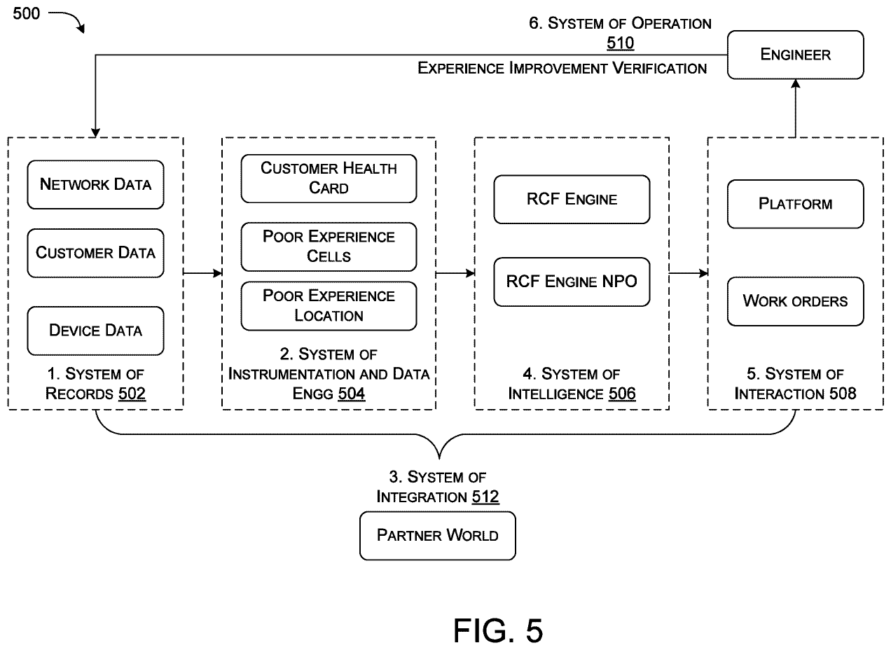

FIG. 5 illustrates an example architecture and a process flow (500) for implementing a method for generating a customer health card, in accordance with an embodiment of the present disclosure.

As illustrated in FIG. 5, in an embodiment, various systems may be integrated with the system (108) (of FIG. 1). A system of records (502) may include network data, device data, and customer data. Output from the system of records (502) may be provided to a system of instrumentation and data engineering (504). This may include the CHC, one or more poor experience cells, and one or more poor experience locations. Output from the system of instrumentation and data engineering (504) may be provided to a system of intelligence (506) that may include a RCF engine BDL (Build, Deployment, and linkage) and a RCF engine NPO (Network Planning and Optimization). Further, an output from the system of intelligence (506) may be provided to a system of interaction (508). The system of interaction (508) may include a visualization platform and one or more workorders. Output from the system of interaction (508) may be provided to a system of operation (510). The system of operation (510) may include an engineer. Further, the system of records (502) and the system of interaction (508) may be integrated with a system of integration (512) to generate required data associated with the CHC.

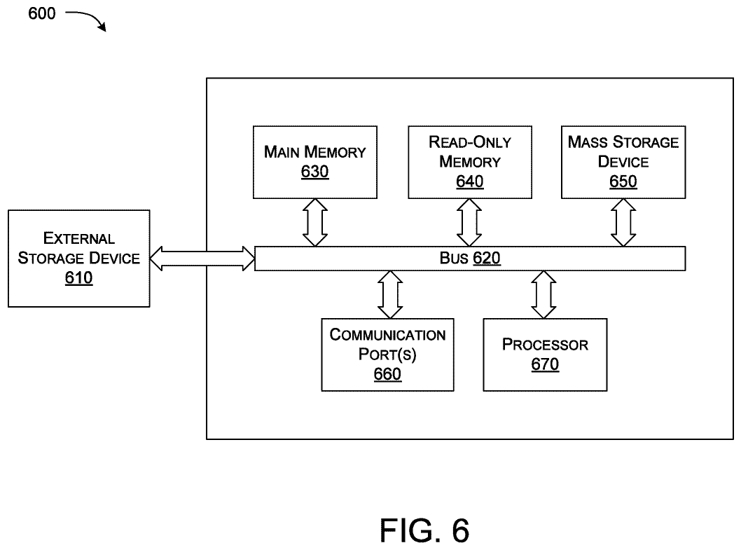

FIG. 6 illustrates an exemplary computer system (600) in which or with which embodiments of the present disclosure may be implemented.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (660) may be chosen depending on a network, such as a Local Area Network (LAN), Wide Area Network (WAN), or any network to which the computer system (600) connects.

In an embodiment, the main memory (630) may be a Random Access Memory (RAM), or any other dynamic storage device commonly known in the art. The read-only memory (640) may be any static storage device(s) e.g., but not limited to, a Programmable Read Only Memory (PROM) chip for storing static information e.g., start-up or basic input/output system (BIOS) instructions for the processor (670). The mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor (670) to the computer system (600).

In another embodiment, operator and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method with a holistic approach that addresses customer's complaints and generates a customer health card (CHC). The CHC corrective actions may be prioritized to ensure benefits to a maximum number of customers.

The present disclosure provides a system and a method that provides a fully automated system that may be easily tweaked with configurable parameters.

The present disclosure provides a system and a method that provides a modular and a scalable solution that accommodates new modules whenever they are developed and a highly scalable framework built on top of a Big Data Analytics platform.

The present disclosure provides a system and a method that reduces manual efforts.

We claim:

1. A system (108) for generating a customer health card (CHC), the system (108) comprising:
a processor (202); and
a memory (204) operatively coupled with the processor (202), wherein said memory (204) stores instructions which, when executed by the processor (202), cause the processor (202) to:
receive a session request from a user (102) via one or more computing devices (104);
receive radio frequency (RF) trace data to determine one or more radio network events associated with the session request;
receive one or more RF counters associated with the one or more radio network events to determine utilization of one or more radio resources during the one or more radio network events;
receive fault data associated with the one or more radio network events to determine an interference in a network (106);
receive configuration data associated with the one or more computing devices (104) and one or more radio resources; and
generate, via a machine learning (ML) engine (214), the CHC based on the RF trace data, the one or more RF counters, the fault data, and the configuration data.

2. The system (108) as claimed in claim 1, wherein the CHC comprises at least one of: one or more RF coverage issues, an outage impact associated with the one or more radio resources, a user experience associated with the interference, an issue with the one or more computing devices (104), and one or more subscriber identity module (SIM) card issues.

3. The system (108) as claimed in claim 1, wherein the processor (202) is to correlate information received from the RF trace data, the one or more RF counters, the fault data, and the configuration data to generate one or more key performance indicators (KPIs) and one or more key quality indicators (KQIs) associated with the CHC.

4. The system (108) as claimed in claim 1, wherein the RF trace data comprises at least one of:
an RF signal strength associated with the one or more computing devices (104);
a distance between the one or more computing devices (104) and the one or more radio resources;
a location of the user (102) associated with the one or more computing devices (104);
information associated with one or more new RF connections established by the one or more computing devices (104);
information associated with the one or more radio resources; and
an amount of data exchanged between the one or more computing devices (104) and the one or more radio resources.

5. The system (108) as claimed in claim 1, wherein the one or more RF counters comprises at least one of:
a resource utilization report indicating the utilization of the one or more radio resources during the one or more radio network events; and
a service usage report indicating an amount of data exchanged between the one or more computing devices (104) and the one or more radio resources.

6. The system (108) as claimed in claim 1, wherein the configuration data comprises at least one of:
a latitude, a longitude, an azimuth, a height, a tilt, and a Multiple-input Multiple-output (MIMO) configuration associated with a base station for communication with the one or more computing devices (104);
a configuration associated with the one or more computing devices (104); and
a configuration associated with a SIM card incorporated with the one or more computing devices (104).

7. The system (108) as claimed in claim 1, wherein the fault data comprises at least one of:
an outage alarm indicating outage information associated with the one or more radio resources; and
an interference alarm indicating the interference in the network (106).

8. A method for generating a customer health card (CHC), the method comprising:
receiving, by a processor (202) associated with a system (108), a session request from a user (102) via one or more computing devices (104);
receiving, by the processor (202), radio frequency (RF) trace data to determine one or more radio network events associated with the session request;
receiving, by the processor (202), one or more RF counters associated with the one or more radio network events to determine utilization of one or more radio resources during the one or more radio network events;
receiving, by the processor (202), fault data associated with the one or more radio network events to determine an interference in the network (106);
receiving, by the processor (202), configuration data associated with the one or more computing devices (104) and one or more radio resources; and
generating, by the processor (202), via a machine learning (ML) engine, the CHC based on the RF trace data, the one or more RF counters, the fault data, and the configuration data.

9. The method as claimed in claim 8, wherein the CHC comprises at least one of: one or more RF coverage issues, an outage impact associated with the one or more radio resources, a user experience associated with the interference, an issue with the one or more computing devices (104), and one or more subscriber identity module (SIM) card issues.

10. The method as claimed in claim 8, comprising correlating, by the processor (202), information received from the RF trace data, the one or more RF counters, the fault data, and the configuration data to generate one or more key performance indicators (KPIs) and one or more key quality indicators (KQIs) associated with the CHC.

11. The method as claimed in claim 8, wherein the RF data comprises at least one of:
an RF signal strength associated with the one or more computing devices (104);
a distance between the one or more computing devices (104) and the one or more radio resources;
a location of the user (102) associated with the one or more computing devices (104);
information associated with one or more new RF connections established by the one or more computing devices (104);
information associated with the one or more radio resources; and
an amount of data exchanged between the one or more computing devices (104) and the one or more radio resources.

12. The method as claimed in claim 8, wherein the one or more RF counters comprises at least one of:
a resource utilization report indicating the utilization of the one or more radio resources during the one or more radio network events; and
a service usage report indicating an amount of data exchanged between the one or more computing devices (104) and the one or more radio resources.

13. The method as claimed in claim 8, wherein the configuration data comprises at least one of:
a latitude, a longitude, an azimuth, a height, a tilt, and a Multiple-input Multiple-output (MIMO) configuration associated with a base station for communication with the one or more computing devices (104);
a configuration associated with the one or more computing devices (104); and
a configuration associated with a SIM card incorporated with the one or more computing devices (104).

14. The method as claimed in claim 8, wherein the fault data comprises at least one of:
an outage alarm indicating outage information associated with the one or more radio resources; and
an interference alarm indicating the interference in the network (106).

15. A user equipment (UE) (104) for sending requests, the UE (104) comprising:
one or more processors communicatively coupled to a processor (202) associated with a system (108), wherein the one or more processors are coupled with a memory, and wherein said memory stores instructions which, when executed by the one or more processors, cause the one or more processors to:
transmit a session request to the processor (202);
wherein the processor (202) is configured to:
receive the session request from the UE (104);
receive radio frequency (RF) trace data to determine one or more radio network events associated with the session request;
receive one or more RF counters associated with the one or more radio network events to determine utilization of one or more radio resources during the one or more radio network events;
receive fault data associated with the one or more radio network events to determine an interference in a network (106);
receive configuration data associated with the UE (104) and one or more radio resources; and
generate, via a machine learning (ML) engine (214), a customer health card (CHC) based on the RF trace data, the one or more RF counters, the fault data, and the configuration data.

16. A non-transitory computer readable medium comprising a processor with executable instructions, causing the processor to:
receive a session request from a user (102) via one or more computing devices (104);
receive radio frequency (RF) trace data to determine one or more radio network events associated with the session request;
receive one or more RF counters associated with the one or more radio network events to determine utilization of one or more radio resources during the one or more radio network events;
receive fault data associated with the one or more radio network events to determine an interference in a network (106);
receive configuration data associated with the one or more computing devices (104) and the one or more radio resources; and
generate, via a machine learning (ML) engine (214), a customer health card (CHC) based on the RF trace data, the one or more RF counters, the fault data, and the configuration data.
